(19) United States
(12) Patent Application Publication
(10) Pub. No.: US 2014/0338500 A1
(43) Pub. Date: Nov. 20, 2014

(54) Paint Can Opener - Paint Brush System

(71) Applicant: Bryan Cridlebaugh, Lewiston, ID (US)

(72) Inventor: Bryan Cridlebaugh, Lewiston, ID (US)

(21) Appl. No.: 14/252,121

(22) Filed: Apr. 14, 2014

Related U.S. Application Data
(60) Provisional application No. 61/811,485, filed on Apr. 12, 2013.

(51) Int. Cl. B67B 7/12; A46B 15/00

(52) U.S. Cl. CPC B67B 7/12; A46B 15/0063
USPC 81/3.27

(57) ABSTRACT

This invention includes embodiments which disclose a tool implement or apparatus which may include a paint can opener implement mountable and removable from a paint brush handle, including a can opener body with a can opener end, a fastener aperture and with one or more protrusions disposed to engage a paint brush handle to which the can opener body is mounted, and a fastener sized and figured to insert through a paint brush handle aperture and fastened to the can opener body utilizing only the paint brush handle aperture and one or more protrusions to removably secure the can opener body to the paintbrush handle.

### CROSS REFERENCE TO RELATED APPLICATION

This application claims priority from U.S. Provisional Application accorded Ser. No. 61/811,485, which was filed Apr. 12, 2013.

### TECHNICAL FIELD

This invention generally relates to a paint can opener system wherein a paint can opener is securely mountable and removable from the handle of a paint brush.

### BACKGROUND OF THE INVENTION

In the construction and remodeling trade, there are numerous situations in which a painter needs to open cans of paint. Often times the lid from the can of paint is tightly adhering to the rim of the can and there is therefore a need for a device or apparatus to assist in the removal of the lid from the paint can. Often times the painters are on ladders and/or otherwise moving around the construction site. Carrying a paint can opener around is just one extra thing and becomes more cumbersome than desired. With most construction workers it is also desirable to minimize the number of tools, devices and apparatuses they need to carry around and be responsible for.

It is also desirable and an object of some embodiments of this invention, to provide such can opener that may be securely attached to a paint brush without modifying the paint brush.

It is therefore an object of embodiments of this invention to provide a paint can opening system in which the can opener may be securely mounted to a paint brush, so that it may be utilized to open a paint can, and can also be removed from the paint brush.

It is also an object of embodiments of this invention to provide such a paint can opening system which utilizes the existing hole or aperture that typically comes in the handle portion of the paint brush.

It is a further object of some embodiments of this invention to provide such a paint can opener that may be securely (but removably) attached to the handle of a paint brush without any substantial modifications or destruction of the paint brush.

Embodiments of this invention therefore have advantages of allowing the can opener to be attached securely to the handle of a paint brush so they can be easily used to open paint cans, while at the same time the existing hole or aperture in the handle may also be used for its intended purpose(s). In some further embodiments of this invention one or more protrusions may be utilized in combination with a fastener through the handle aperture, to further secure the paint can opener to the paint brush.

While the invention was motivated in addressing some objectives, it is in no way so limited. The invention is only limited by the accompanying claims as literally worded, without interpretative or other limiting reference to the specification, and in accordance with the doctrine of equivalents. Other objects, features, and advantages of this invention will appear from the specification, claims, and accompanying drawings which form a part hereof. In carrying out the objects of this invention, it is to be understood that its essential features are susceptible to change in design and structural arrangement, with only one practical and preferred embodiment being illustrated in the accompanying drawings, as required.

### BRIEF DESCRIPTION OF THE DRAWINGS

Preferred embodiments of the invention are described below with reference to the following accompanying drawings.

FIG. 1 is an end perspective view of one example of an embodiment of the paint can opener mounted on a paint brush;

FIG. 2 is another perspective view of the example of the embodiment of the invention illustrated in FIG. 1;

FIG. 3 is a bottom perspective view of the example of the embodiment of the invention illustrated in FIGS. 1 & 2;

FIG. 4 is a top view of the example of the embodiment of the can opener illustrated in FIG. 1;

FIG. 5 is a side view of the example of the embodiment of the can opener illustrated in FIG. 1;

FIG. 6 is a perspective view of the example of the embodiment of the can opener illustrated in FIG. 1;

FIG. 7 is a bottom side perspective exploded view of the example of the embodiment of the can opener illustrated in FIGS. 1-3;

FIG. 8 is a bottom view of another example of an embodiment of a can opener which may be utilized in practicing this invention;

FIG. 9 is a side section view 9-9 from FIG. 8;

FIG. 10 is an end section 10-10 from FIG. 8; and

FIG. 11 is a perspective view of the example of the embodiment of the invention illustrated in FIG. 8.

### DETAILED DESCRIPTION OF THE PREFERRED EMBODIMENTS

Many of the fastening, connection, manufacturing and other means and components utilized in this invention are widely known and used in the field of the invention described, and their exact nature or type is not necessary for an understanding and use of the invention by a person skilled in the art or science; therefore, they will not be discussed in significant detail. Furthermore, the various components shown or described herein for any specific application of this invention can be varied or altered as anticipated by this invention and the practice of a specific application or embodiment of any element may already be widely known or used in the art or by persons skilled in the art or science; therefore, each will not be discussed in significant detail.

The terms “a”, “an” and “the” as used in the claims herein are used in conformance with long-standing claim drafting practice and not in a limiting way. Unless specifically set forth herein, the terms “a”, “an” and “the” are not limited to one of such elements, but instead mean “at least one”.

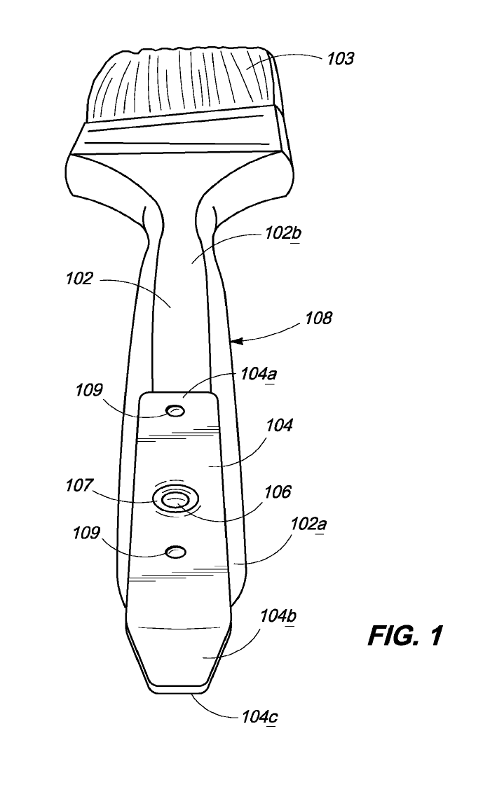

FIG. 1 is an end perspective view of one example of an embodiment of paint can opener 101 mounted on paint brush 108, and shows paint brush with paint brush bristles 103, a paint brush handle 102 with a neck 102b and a handle end 102a. Paint can opener 101 is shown mounted to the handle 102 of the paint brush 108, with can opener body 104 mounted longitudinally on the paint brush handle 102. The opener end 104b is shown with opening and edge 104c which is the portion of the can opener body 104 which is utilized to engage a paint can between a paint can lid and a paint can rim, thereby allowing the user to pry the paint can lid out of its seated position within the rim of the paint can.

The can opener body 104 is securely, but removably, attached to paint brush handle 102 by means of a fastener such as a screw combined with sufficient threads provided within can opener body 104 (as shown and described in other figures below). The can opener body 104 has a second end 104a and is preferably made of steel or metal of sufficient strength at the can opener end 104b to allow it to pry loose the tightest lids from paint cans. FIG. 1 further shows the paint brush handle aperture 106 which is typical on most paint brushes and normally provides a location for the paint brush to be hung from. FIG. 1 further shows a threaded fastener 107 which is integral with can opener body 104 and provides threads for a fastener such as a screw or bolt to engage to secure the can opener body 104 to the paint brush handle 102.

In order to have one or more additional points of attachment to more desirably secure the can opener body 104 to the paint brush handle 102, one or more but preferably two protrusions, may be placed in the can opener body 104. Because intrusions are on the opposite side of the can opener body 104, they cannot be seen in FIG. 1; however, a preferred way of creating the protrusions 105 is to do it punch or stamp and in doing so indentations 109 are created on the side of can opener body 104 shown in FIG. 1. The protrusions are better illustrated in FIG. 5.

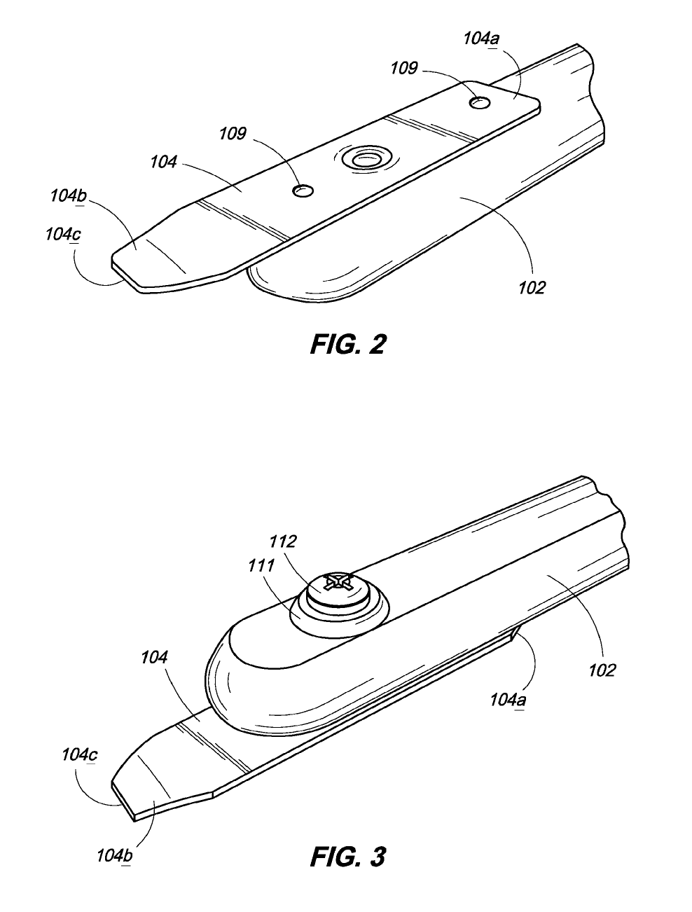

FIG. 2 is another perspective view of the example of the embodiment of the invention illustrated in FIG. 1, illustrating paint brush handle 102, can opener body 104, and indentations 109 in the can opener body 104. FIG. 2 further shows the can opener end 104b of can opener body 104, the opening edge 104c and the second end 104a of can opener body 104.

FIG. 3 is a bottom perspective view of the example of the embodiment of the invention illustrated in FIGS. 1 & 2, illustrating paint brush handle 102, and can opener body 104 with can opener end 104b. It can be seen from FIG. 3 how a fastener 112 (such as a screw in this example) may be utilized in combination with a washer 111 to secure can opener body 104 to paint brush handle 102. The screw or fastener 112 may be rotated or inserted into an internally threaded fastener aperture in the can opener body 104.

It will be appreciated by those of ordinary skill in the art that no one particular type of fastener to practice this invention, but instead any one of a number of different types of fasteners may be utilized, such as screws and bolts of all kinds, rivets, and others. It will be further appreciated that in the event a screw or threaded members utilized, the threads may be provided separately by or they may be integral within or part of the can opener body 104, as shown in FIG. 5 as item 117.

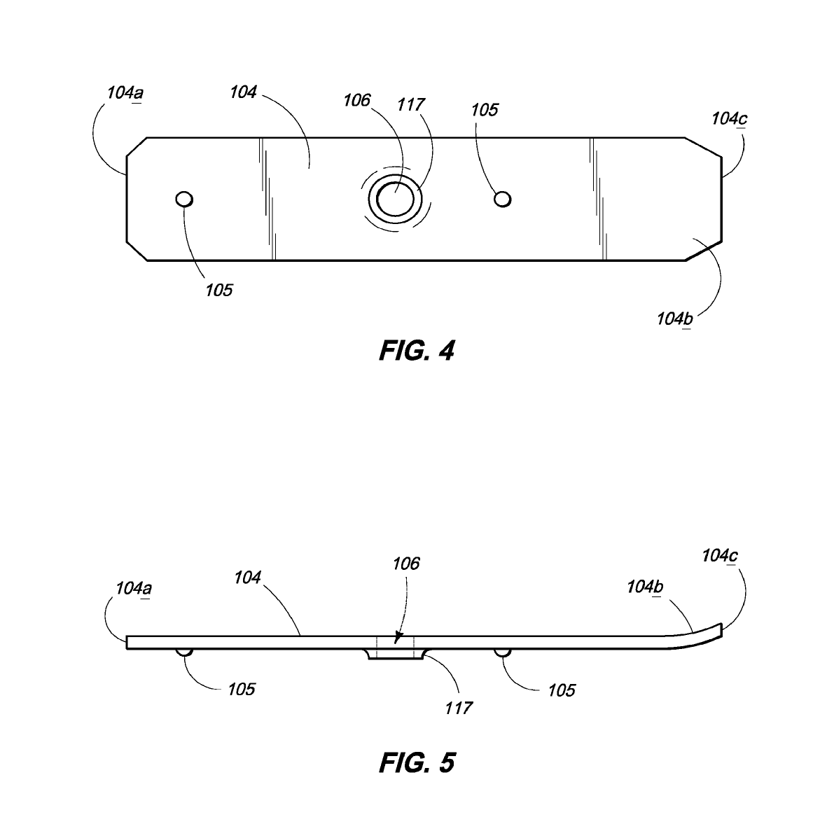

FIG. 4 is a top view of the example of the embodiment of the can opener system illustrated in FIG. 1, showing can opener body 104 with can opener end 104b, protrusions 105 are configured to sufficiently engage with the paint brush handle to prevent the can opener body 104 rotating about the fastener utilized to attach it to the paint brush handle. FIG. 4 further shows the paint can opener threaded portion 117 is integral to the can opener body 104 and provides sufficient internal threading to allow a threaded fastener such as fastener 112 illustrated in FIG. 3 to be fastened or operably attached.

It will be appreciated by those of ordinary skill in the art that the can opener body may be made out of any one or more different materials, such as steel, aluminum alloys and others. The material selection for the can opener end 104b must simply provide the desired strength to be able to remove lids from paint cans.

FIG. 5 is a side view of the example of the embodiment of the can opener illustrated in FIG. 1, showing can opener body 104, body aperture 106, threaded portion 117, protrusions 105 and the can opener end 104b of can opener body 104.

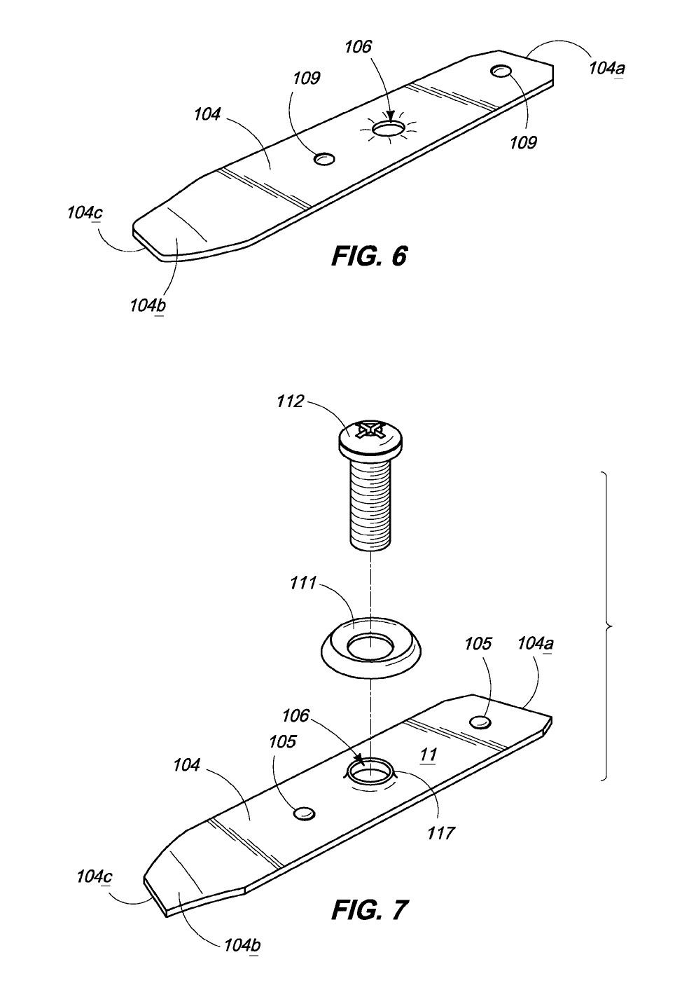

FIG. 6 is a perspective view of the example of the embodiment of the can opener illustrated in FIG. 1, showing can opener body 104, can opener body aperture 106, indentations 109 corresponding to the protrusions 105 shown in other figures, and the opener end 104b of the can or body 104.

FIG. 7 is a bottom side perspective exploded view of the example of the embodiment of the can opener illustrated in FIGS. 1-3, illustrating can opener body 104 with can opener end 104b, then opener body aperture 106, washer 111 and fastener 112 corresponding to the washer 111 and can opener body aperture 106. Showing hidden lines is can opener body threaded portion 117.

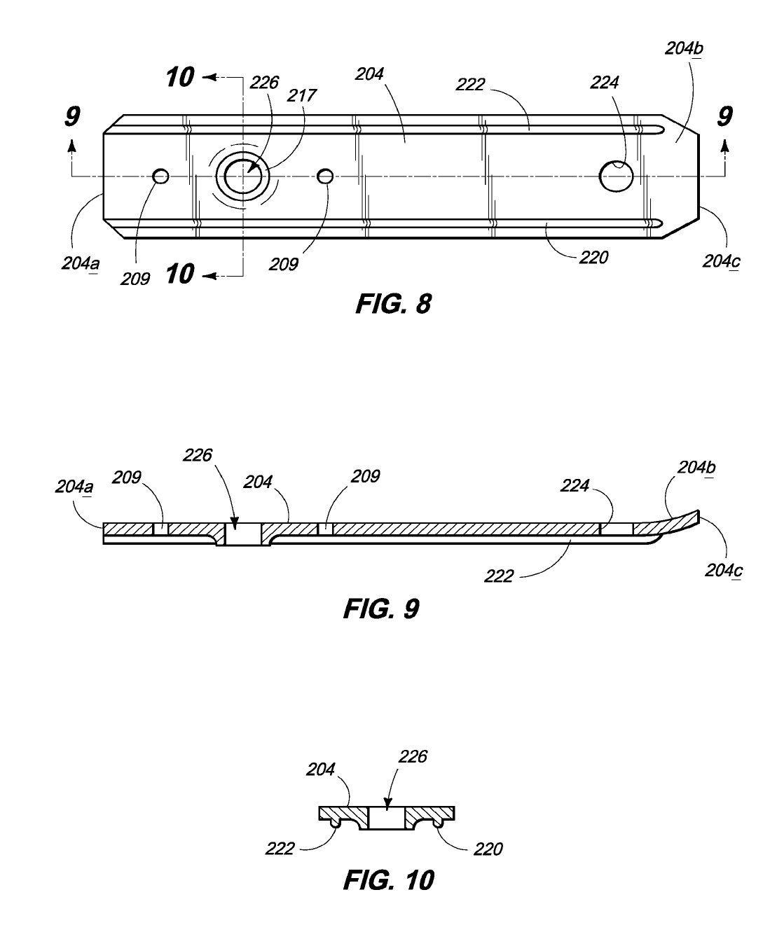

FIG. 8 is a bottom view of another example of an embodiment of a can opener which may be utilized in practicing this invention, can opener body 204 with can opener end 204b, indentations 205 which are configured to sufficiently engage the paint brush handle to prevent the can opener body 204 from rotating about the fastener utilized to attach it to the paintbrush handle. FIG. 8 further shows the paint can opener threaded portion 217 integral to the can opener body 204, and in the threaded fastener embodiments of this invention, provides sufficient internal threading to allow a threaded fastener to be fastened or operably attached.

FIG. 8 further shows structural supports 220 and 222 which may be ribs longitudinally oriented along can opener body 204 to provide additional strength and rigidity to prevent deformation of the can opener body 204 when a paint can is being opened. The second end 204a of the can opener body 204 and can opener body aperture 226 are also shown in FIG. 8.

FIG. 9 is a side section view 9-9 of the example of the embodiment of the invention illustrated in FIG. 8, illustrating can opener body 204, body aperture 226, threaded portion 217, protrusions 205, and the can opener end 204b of can opener body 204. FIG. 9 further shows structural supports 220 and 222 which may be rails or ribs, longitudinally oriented along can opener body 204.

FIG. 10 is an end section view 10-10 from FIG. 8, showing can opener body 204, can opener body aperture 226, and structural support rails 220 and 222.

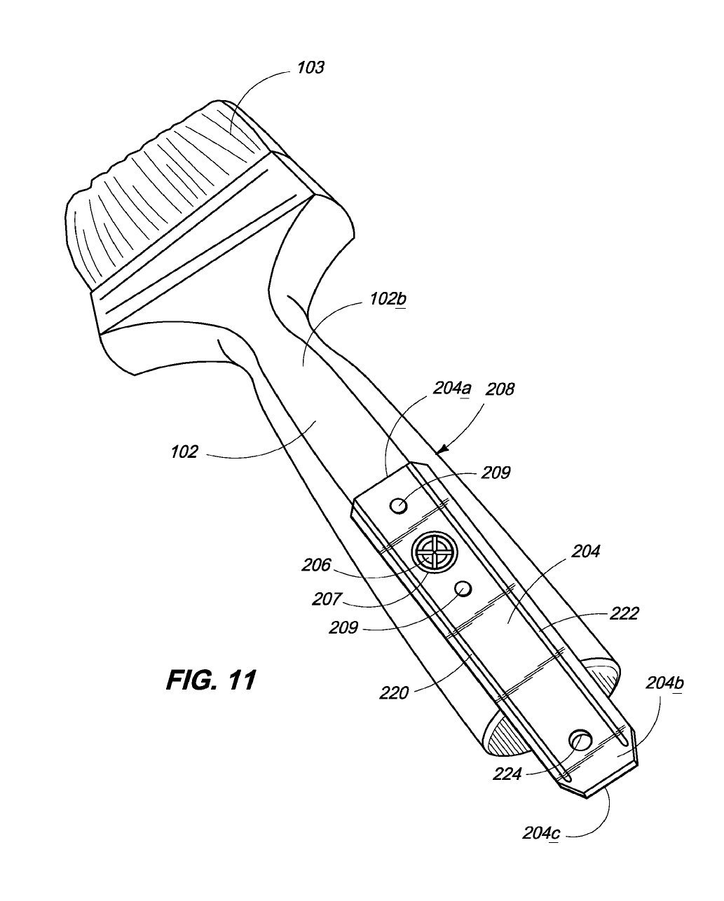

FIG. 11 is a perspective view of the example of the embodiment of the invention illustrated in FIG. 8, fastened to or mounted on a paint brush handle 102 of paint brush 108. FIG. 11 illustrates paintbrush 108 with paint brush handle 102 with a neck 102b and a handle end 102a. The paint can opener illustrated in FIG. 11 is mounted longitudinally on paint brush handle 102, and further shown in FIG. 11 are indentations 209, faster 206, washer 207 and structural supports 220 and 222. At the can opener end 204b of can opener body 204 is edge 204c which is utilized to wage between the lid on the paint can and the brim or paint of the paint can and used as a lever to pry or remove the paint can lid from the paint can.

As will be appreciated by those of reasonable skill in the art, there are numerous embodiments to this invention, and variations of elements, components and combinations, which may be used, all within the scope of this invention.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A paint can opener implement mountable and removable from a paint brush handle, comprising:
a can opener body with a can opener end, a fastener aperture and with one or more protrusions disposed to engage a paint brush handle to which the can opener body is mounted;
a fastener sized and figured to insert through a paint brush handle aperture and fastened to the can opener body utilizing only the paint brush handle aperture and one or more protrusions to removably secure the can opener body to the paintbrush handle.

2. The paint can opener implement recited in claim 1, and further wherein one or more longitudinal structural supports are interval with can opener body.
